(19) United States
(12) Patent Application Publication
(10) Pub. No.: US 2011/0001785 A1
(43) Pub. Date: Jan. 6, 2011

(54) Image forming system

(75) Inventors: Yoshiyuki Tsuzawa, Kanagawa-ken (JP); Yasuhiko Kachi, Kanagawa-ken (JP); Hiroshi Kawakami, Fujinomiya-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/801,751

(22) Filed: Jun. 23, 2010

(30) Foreign Application Priority Data
Jul. 3, 2009 (JP) 2009-158653

(51) Int. Cl. B41J 2/01

(52) U.S. Cl. 347/104

(57) ABSTRACT

An image forming system includes: a recording medium which has a roll shape and is manufactured so as to have both edges curling in a direction opposite to a roll surface of the recording medium; an image forming device which forms an image on the recording medium conveyed along a conveyance path; a recording medium feeder in which the recording medium having the roll shape is loaded in such a manner that the recording medium having the roll shape is conveyed while the roll surface of the recording medium faces the image forming device; a rear end cutter for cutting the recording medium having the roll shape on which the image forming device has formed an image on the roll surface at a position posterior to the formed image; a reverse conveyance path in which the recording medium, on the roll surface of which the image has been formed and which has been cut by the rear end cutter, is reversed in terms of front and back surfaces of the recording medium; and a decurl device for reversing a curl direction of the recording medium which has been reversed in terms of the front and back surfaces and is conveyed in the reverse conveyance path, wherein images are formed on the front and back surfaces of the recording medium by forming an image on the front surface of the recording medium having the roll shape, cutting the recording medium at the position posterior to the image, reversing the recording medium in terms of the front and back surfaces, reversing curl of the edges of the recording medium in an opposite direction by the decurl device, and then forming an image on the back surface of the recording medium.

### BACKGROUND OF THE INVENTION

1. Field of the Invention

The present invention relates to an image forming system, and more particularly, to an image forming system which performs recording at high quality onto both surfaces of roll-shaped recording paper for double-side printing which is manufactured by cutting from a large roll by a slitter.

2. Description of the Related Art

In an image forming apparatus, a magazine loaded with roll paper (continuous paper) is used as a paper feed unit, for example, and roll paper is drawn out from the magazine, and supplied to the print unit, either in a rolled state, or after cutting to form a paper sheet, whereupon image formation is carried out.

However, the rolled paper has residual curl due to having been loaded in the magazine. Furthermore, even if using recording paper which has been cut into sheets, after image formation, the recording paper curls due to heat when the paper is fixed by heating.

Therefore, in order to improve image quality by removing the curl occurring in the recording paper, a decurl apparatus which removes curl has been provided in image forming apparatuses. FIG. 7 shows one example of a decurl apparatus. As illustrated in FIG. 7, while the recording paper P is conveyed inside the decurl apparatus, the curl is removed by decurl rollers 90a and 90b.

For example, there is an image forming apparatus which carries out recording while scanning a recording head reciprocally in a direction perpendicular to the feed direction of recording paper, wherein an image of high definition is formed by maintaining a uniform distance between the recording paper and the recording head at all times, by means of a decurling mechanism which comprises a conveyance path that corrects roll paper in the opposite direction to the direction in which the paper is curved (see, for example, Japanese Patent Application Publication No. 2007-130932).

Furthermore, there is an image forming apparatus which carries out image formation by drawing out and cutting recording paper from a roll of recording paper wound in a roll shape, in which an upper side decurl device and a lower side decurl device which correct curl in the paper are disposed respectively on the upstream side in terms of the conveyance direction with respect to a movable blade and a fixed blade which cut the roll-shaped recording paper, and high-speed conveyance is made possible despite the presence of the decurl devices, by carrying out the cutting operation by the movable blade and the fixed blade and the correction of curl by the upper side decurl device and the lower side decurl device, in a substantially simultaneous fashion (see, for example, Japanese Patent Application Publication No. 2007-145485).

Furthermore, there is also an image forming apparatus which performs printing onto both surfaces of long paper, such as roll paper, wherein printing is carried out onto a first surface of roll paper of a prescribed length and then the paper is output, whereupon the paper is wound up onto a roll in such a manner that the first surface, onto which printing has already been performed, is toward the inner side, in order to print on the second surface, thereby reversing the paper after printing on the front surface and decurling the paper before printing on the back surface (see, for example, Japanese Patent Application Publication No. 2008-126530).

Furthermore, in inkjet recording, in order to record a borderless image of high definition, gutter sections are provided on the recording paper and image formation is generally carried out by depositing ink droplets up to an area exceeding the paper width. However, in this case, if using recording paper manufactured by slitting a large roll with a slitter in the lengthwise direction and winding the paper up in a roll shape, burr created by the slitting of the recording paper occurs in the vicinity of the edges of the recording paper and the edges curl to one side. If ink droplets are deposited onto edges containing such burr in this way, the recording paper may float up due to the effects of the burr and accurate control of ink deposition is not possible, and as a result, the image may become blurred and a clean image may not be obtained.

Furthermore, if images are formed by depositing ink droplets up to an area exceeding the paper width in this way, desirably, the edges curl in the direction opposite to the side on which ink droplets are deposited. For example, as illustrated in FIG. 8, when recording by ejecting ink droplets 93 onto the surface of recording paper P by scanning an inkjet recording head 92 in the direction (indicated by the left and rightward arrows in FIG. 8) perpendicular to the conveyance direction of the recording paper P, while conveying the recording paper P in the direction perpendicular to the plane of the drawing (the direction passing through the plane of the drawing), desirably, the curl Pd of the recording paper P is in the opposite direction to the surface on which the ink droplets 93 are deposited (towards the lower side in FIG. 8).

However, in the case of double-side printing, since both surfaces are recording surfaces, then either side suffers burring (curl) and hence there is a possibility that the image may be consequently be degraded on either one of the front or back surfaces of the recording paper. In this case, for example, even if, after printing on the front surface where the curl is in the downward direction, the recording paper is turned over and before printing on the back surface, it is sought to flatten the burr and reverse the curl of the edges in the opposite direction by using a decurl device, then if the width of the decurl roller 94 is narrower than the width of the recording paper P, as illustrated in FIG. 8, for example, there is a possibility that the burring of the edges cannot be flattened and high-definition double-side recording cannot be achieved. FIG. 8 depicts a decurl roller 94 being situated directly below the inkjet recording head 92, but this is merely a diagram for illustrating the relationship between the width of the recording paper P and the width of the decurl roller 94, and in actual practice, a decurl roller 94 is not situated in this position; furthermore, the upper roller of the decurl roller 94 is not depicted (is omitted) in the drawing.

In this way, when carrying out double-side recording by supplying a roll-shaped recording paper, there is a possibility that it is difficult to achieve high-definition image recording on both surfaces of the paper, depending on the direction of conveyance of the recording paper and the direction of curl.

### SUMMARY OF THE INVENTION

The present invention has been contrived in view of these circumstances, an object thereof being to provide a simple and inexpensive image forming system whereby double-side recording of high definition can be carried out by supplying double-side recording medium having excellent quality and improving end face peeling due to infiltration of ink into the end faces of the paper.

In order to attain an object described above, one aspect of the present invention is directed to an image forming system comprising: a recording medium which has a roll shape and is manufactured so as to have both edges curling in a direction opposite to a roll surface of the recording medium; an image forming device which forms an image on the recording medium conveyed along a conveyance path; a recording medium feeder in which the recording medium having the roll shape is loaded in such a manner that the recording medium having the roll shape is conveyed while the roll surface of the recording medium faces the image forming device; a rear end cutter for cutting the recording medium having the roll shape on which the image forming device has formed an image on the roll surface at a position posterior to the formed image; a reverse conveyance path in which the recording medium, on the roll surface of which the image has been formed and which has been cut by the rear end cutter, is reversed in terms of front and back surfaces of the recording medium; and a decurl device for reversing a curl direction of the recording medium which has been reversed in terms of the front and back surfaces and is conveyed in the reverse conveyance path, wherein to images are formed on the front and back surfaces of the recording medium by forming an image on the front surface of the recording medium having the roll shape, cutting the recording medium at the position posterior to the image, reversing the recording medium in terms of the front and back surfaces, reversing curl of the edges of the recording medium in an opposite direction by the decurl device, and then forming an image on the back surface of the recording medium.

According to this aspect of the invention, when double-side recording is carried out by supplying recording paper having a roll shape, the decurl unit which is provided for the purpose of double-side recording is used, and thereby it is possible always to form an image on a surface on which the edges curl in the opposite direction to the image forming surface. Therefore, end face peeling due to infiltration of ink into the edges is improved and double-side recording of high definition can be achieved simply and at low cost.

Desirably, the recording medium having the roll shape is manufactured by cutting a paper supplied from a large roll with a slitter in a direction in which the paper is conveyed, and taking up the cut paper in form of a roll in such a manner that a surface of the cut paper which is reverse to a side on which the edges of the cut paper curl forms the roll surface.

In this way, in the stage of manufacturing recording paper having a roll shape, the edges of the first recording surface in double-side recording curl in the opposite direction to the recording surface, and therefore when an image is recorded on the front surface of the recording paper having a roll shape, it is possible to record an image of high definition directly onto the first surface in double-side recording.

Desirably, the decurl device includes a decurl roller for pressurizing at least the edges of the recording medium.

According to this aspect of the invention, since the decurl roller always presses against (stamps on) the edges of the recording medium, it is possible to reverse the curl of the edges in the direction opposite to the surface of the medium.

Desirably, the decurl roller has a uniform hardness enabling the curl of the edges of the recording medium to be reversed in the opposite direction.

According to this aspect of the invention, the decurl roller of the decurl device is able to reverse the curl of the edges of the recording medium in a reliable fashion.

Desirably, the image forming device forms an image on a surface of the recording medium which is reverse to a side on which the edges of the recording medium curl.

According to this aspect of the invention, it is possible to record images of high definition on both surfaces of a recording medium.

As described above, according to the present invention, when double-side recording is carried out by supplying recording paper having a roll shape, it is possible always to form an image on a surface on which the edges curl in a direction opposite to the surface, by using the decurl unit which is provided for the purpose of double-side recording, and therefore end face peeling due to infiltration of ink into the edges is improved and double-side recording of high definition can be achieved simply and at low cost.

### BRIEF DESCRIPTION OF THE DRAWINGS

FIG. 1 is a schematic drawing illustrating an overview of one embodiment of an image forming system relating to the present invention;

FIG. 2 is a general schematic drawing illustrating an approximate view of an image forming apparatus in an image forming system;

FIG. 3 is a perspective diagram showing the approximate composition of a suction conveyance unit;

FIG. 4 is a cross-sectional diagram in the breadthways direction of the suction conveyance unit;

FIG. 5 is a principal part schematic drawing illustrating an overview of an electrical system of an image forming apparatus according to an embodiment of the present invention;

FIG. 6 is an illustrative diagram showing the relationship between the width of the recording paper and the width of the decurl device according to an embodiment of the present invention

FIG. 7 is a schematic drawing illustrating an overview of a decurl apparatus; and

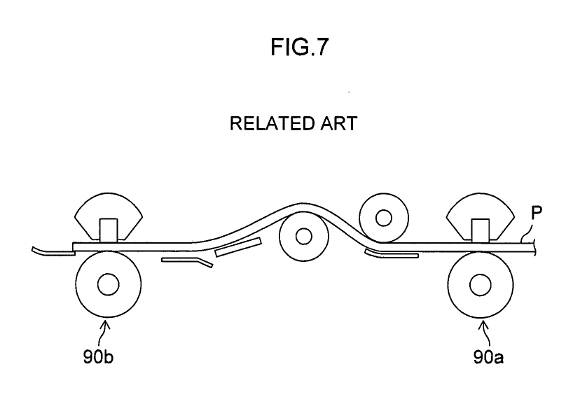

FIG. 8 is an illustrative diagram showing the relationship between the width of the recording paper and the width of the decurling device according to the related art.

### DESCRIPTION OF THE PREFERRED EMBODIMENTS

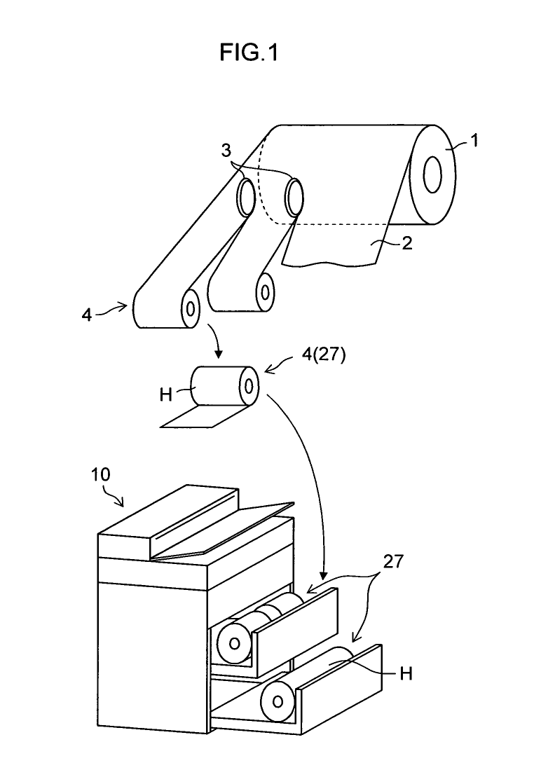

FIG. 1 is a schematic drawing illustrating an overview of one embodiment of an image forming system relating to the present invention.

As illustrated in FIG. 1, the image forming system according to the present embodiment comprises recording paper manufacturing equipment, in which paper 2 is drawn out from a huge roll 1 and slit by a slitter 3 so as to divide the paper into plural sheets of recording paper of a prescribed width, each of which is wound up as small recording paper 4, and this paper is used as roll-shaped recording paper 27 (4) which is installed in a paper feed unit of an image forming apparatus 10.

The huge roll 1 may have a diameter of 1 m (meter) and a width of 3 m approximately, for example, and the small recording paper 4 which is wound up may have various sizes, for instance, a diameter of 20 cm and a width ranging from a small value of 89 mm to a large value of 30 cm or greater.

Furthermore, the slitter 3 slits (cuts) the paper 2 in the drawing out direction (conveyance direction), and is, for example, a commonly known cutter based on a rotary cutter, or the like. In this case, each of the recording papers 4 (27) is manufactured in such a manner that both edges on the outer side surface H of the recording paper 4 (27) curl in the direction opposite to the surface H.

Although described in detail below, when the roll-shaped recording paper 27 manufactured in this way is installed in a paper feed unit of an image forming apparatus 10, the paper is drawn out and firstly an image is formed on the outer side surface H (first surface) of the roll. In this case, as described above, the paper is manufactured in such a manner that the edges of the surface H curl in the direction opposite to the surface.

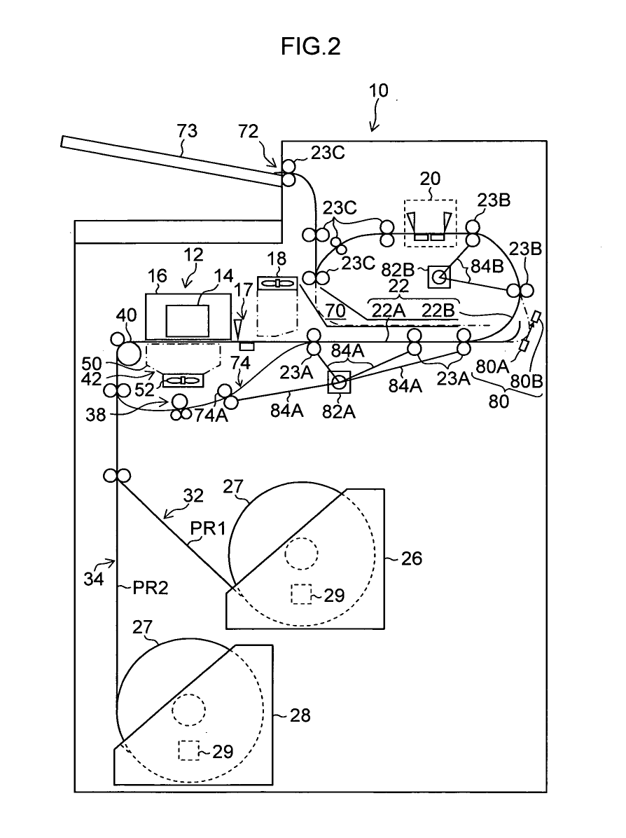

FIG. 2 is a general schematic drawing illustrating an approximate view of an image forming apparatus 10 in the present image forming system.

As illustrated in FIG. 2, the image forming apparatus 10 relating to the present embodiment comprises an image forming unit 12 which forms an image, or the like, on the recording paper, and the image forming unit 12 has an inkjet recording head 14 which ejects ink droplets toward the recording paper and a carriage 16 which holds the inkjet recording head 14.

The present embodiment is described below with respect to a color image forming apparatus 10 which forms color images of the four colors of Y (yellow), M (magenta), C (cyan) and K (black), but the image forming apparatus is not limited to this and needless to say, the present invention may also be applied to a monochrome image forming apparatus.

Moreover, the image forming apparatus 10 comprises a rear end cutter 17 for cutting the rear end of the long (roll-shaped) recording paper, a drier 18 which supplies a drying air flow to the surface of the recording paper on which an image has been formed by the inkjet recording head 14 thereby solidifying the ink droplets, a cutter (first cutter) 20 which cuts the recording paper into respective images, and a main conveyance path 22 along which the recording paper is conveyed from the inkjet recording head 14 to the rear end cutter 17, the drier 18 and the cutter 20 successively.

In FIG. 2, two blades are depicted as cutters 20, but the number of blades is not limited to two and one cutter blade may be used.

The main conveyance path 22 comprises a horizontal section 22A which conveys the recording paper in the horizontal direction and a changing and bending section 22B which changes the direction of conveyance of the recording paper conveyed in the horizontal direction to a U-shape having a prescribed curvature towards the upper side, as well as bending the recording paper.

The image formation position by the inkjet recording head 14, the cutting position by the rear end cutter 17 and the supply position of the drying air flow by the drier 18 are disposed in this sequence in the horizontal portion 22A. Furthermore, a plurality of roller pairs 23A are disposed in the horizontal portion 22A for conveying the recording paper in accordance with the processing speed of image formation by the inkjet recording head 14.

Moreover, a plurality of roller pairs 23B for conveying the recording paper in accordance with the processing speed of cutting by the cutter 20 are provided in the changing and bending section 22B of the main conveyance path 22. This changing and bending section 22B forms a buffer capable of temporarily holding recording paper by temporarily interrupting the conveyance of the recording paper and bending the recording paper outwards. As illustrated in FIG. 2, in the present embodiment, the changing and bending section (buffer) 22B is composed in such a manner that the conveyance of the recording paper can be interrupted temporarily in the portion where the conveyance direction of the recording paper is changed initially.

A paper sensor 80 which determines the presence of recording paper is provided in the changing and bending section (buffer) 22B at a position where the equivalent of one sheet of recording paper is held and the recording paper is bent outwards, in the case of the largest image size that can be formed. The paper sensor 80 comprises, for example, a light emitting element 80A and a light receiving element 80B disposed so as to oppose each other, in such a manner that the recording paper is determined by detecting that the light from the light emitting element 80A which ought to be received by the light receiving element 80B has been to shielded by the recording paper.

The recording paper which has passed through the changing and bending section 22B is conveyed to the cutter 20, and is cut into respective images by the cutter 20. The recording paper which has been cut into respective images is then conveyed by a plurality of roller pairs 23C, stored temporarily in a switchback accommodating section 70, and the conveyance direction therefore is then reversed and the paper is output via the paper output port 72 to the tray 73.

Furthermore, the image forming apparatus 10 comprises a reverse conveyance path 74 for double-side printing. The reverse conveyance path 74 comprises a roller pair 74A. In the reverse conveyance path 74, the recording paper on which an image has been formed on one surface by the inkjet recording head 14 is reversed in terms of the front and back surfaces and the paper is supplied again to the main conveyance path 22. Consequently, it is possible to form images on both surfaces of the recording paper.

The roller pairs 23A in the main conveyance path 22 and the roller pairs 74A in the reverse conveyance path 74 are driven to rotate by a driving force which is transmitted from a motor 82A via the drive transmission path 84A, the roller pairs 23B of the changing and bending section 22B are driven to rotate by a driving force transmitted from a motor 82B via a drive transmission path 84B.

More specifically, in the present embodiment, the drive source and the drive transmission path for driving the roller pairs 23A and the roller pair 74A are provided separately from the drive source and drive transmission path for driving the roller pairs 23B.

Furthermore, the image forming apparatus 10 comprises a first roll type paper feed unit 26 and a second roll type paper feed unit 28 which supply a recording paper of long dimensions. Apart from this, the image forming apparatus 10 comprises a sheet type paper feed unit which supplies recording paper PS having a sheet shape, in such a manner that recording paper is accommodated with the upper surface side of the recording paper facing toward the open air side.

The first roll type paper feed unit 26 and the second roll type paper feed unit 28 are capable of accommodating roll-shaped recording paper 27 in which long recording paper of different widths from 102 mm to 254 mm, for example, has been wound in a roll shape. A plurality of mechanical switches (not illustrated) for determining the width of the accommodated roll-shaped recording paper 27 are provided in the first roll type paper feed unit 26 and the second roll type paper feed unit 28.

Moreover, a remaining amount sensor 29 for determining the remaining amount of the roll-shaped recording paper 27 on the basis of the thickness of the roll-shaped recording paper 27 is provided in each of the first roll type paper feed unit 26 and the second roll type paper feed unit 28. The remaining amount sensors 29 may also determine the remaining amount of paper on the basis of the weight of the roll-shaped recording paper 27, rather than the thickness thereof.

The image forming apparatus 10 comprises a first roll conveyance unit 32 which conveys long recording paper PR1 paid out from the first roll type paper feed unit 26, and a second roll conveyance unit 34 which conveys long recording paper PR2 paid out from the second roll type paper feed unit 28 (below, for the purposes of the description, the recording papers PR1 and PR2 may be referred to generally as the recording paper P).

Furthermore, the image forming apparatus 10 comprises a first roll type paper feed unit 26, a second roll type paper feed unit 28, and a sub-scanning roller 40 which conveys the recording paper P from the reverse conveyance path 74 to the main conveyance path 22. Long recording papers PR1, PR2 (roll-shaped recording papers 27) are conveyed selectively to the main conveyance path 22 via the sub-scanning roller 40.

The recording paper P is photographic printing paper which is used for photographic printing, or normal paper, for instance. In the case of the photographic printing paper, a coating layer containing water-absorbing silica particles is formed on either surface. Consequently, as drying progresses on one surface of the recording paper P, the coating layer on this one surface contracts and the surface curls so as to assume a concave shape. Furthermore, in the case of normal paper, in a similar fashion, when the one surface makes contact with the air, drying of this surface progresses, contraction of the paper fibers progresses, and this one surface curls so as to assume a concave shape. Moreover, paper having a coating layer containing water-absorbing silica particles on both surfaces which has been used for photograph books in recent years also has similar properties. Furthermore, in the case of roll-shaped recording paper 27, since the paper has been wound in a roll shape, then the inner side in which the paper is wound curls so as to assume a concave shape.

Therefore, a suction conveyance unit 42 is provided in the main conveyance path 22 so as to keep a uniform distance between the recording paper P and the inkjet head 14 while ensuring the flatness of the recording paper P conveyed to the image forming position by the inkjet recording head 14. This suction conveyance unit 42 suctions and conveys the recording paper P conveyed from the sub-scanning roller 40 to the region where the image is to be formed by the image forming unit 12 (in other words, directly below the inkjet recording head 14).

Furthermore, a decurl conveyance unit 38 for decurling the recording paper is provided in the reverse conveyance path 74. The decurl conveyance unit 38 carries out decurling of the recording paper on which an image has been formed and the upper surface of which is curled in a concave shape, and causes the paper to curl in such a manner that the surface thereof is convex on the main conveyance path 22.

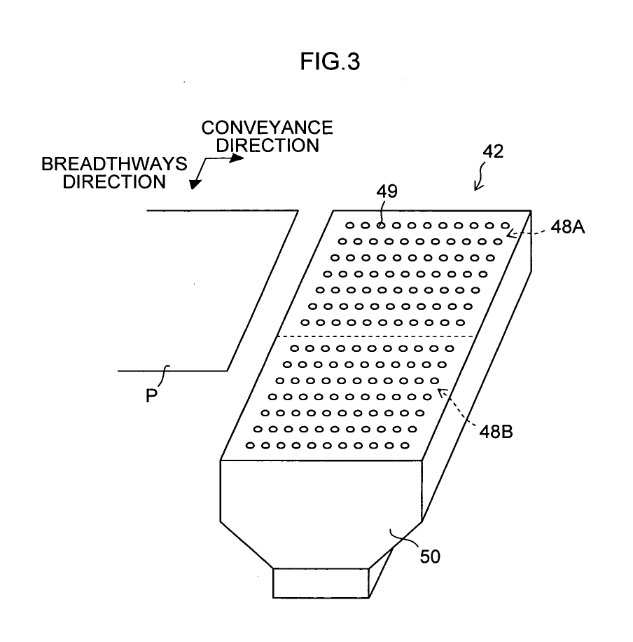

FIG. 3 is a perspective diagram showing the approximate composition of the suction conveyance unit 42.

As illustrated in FIG. 3, the suction conveyance unit 42 is constituted by an air chamber forming member 50 which forms two air chambers 48A, 48B in the breadthways direction of the recording paper P (a direction substantially perpendicular to the conveyance direction of the recording paper P (the left/right direction in FIG. 3)), and the upper surface thereof forms the main conveyance path 22. The air chamber forming member 50 is formed so that the width corresponding to the breadthways direction of the recording paper P is greater than the maximum width of the recording paper P which can be used in the image forming apparatus 10 according to the present embodiment. Furthermore, a plurality of suction holes 49 for connecting to the air chambers 48A, 48B and the main conveyance path 22 side are formed in the upper surface of the air chamber forming member 50 which forms the main conveyance path 22.

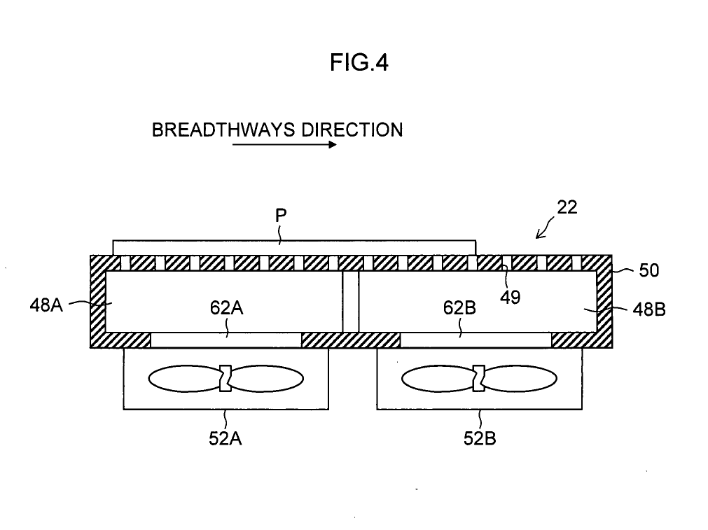

FIG. 4 is a cross-sectional diagram in the breadthways direction of the suction conveyance unit 42.

As illustrated in FIG. 4, suction fans 52A and 52B which perform negative pressure suctioning are provided respectively in corresponding positions below the air chambers 48A and 48B, which are formed in the air chamber forming member 50. Furthermore, openings 62A and 62B are formed in the bottom surface side of the air chamber forming member 50, in such a manner that the suction fans 52A and 52B connect respectively with the air chambers 48A and 48B.

Moreover, as illustrated in FIG. 4, the recording paper P is conveyed to the suction conveyance unit 42 in such a manner that one end thereof in the breadthways direction substantially coincides with one end of the air chamber forming member 50 in the breadthways direction.

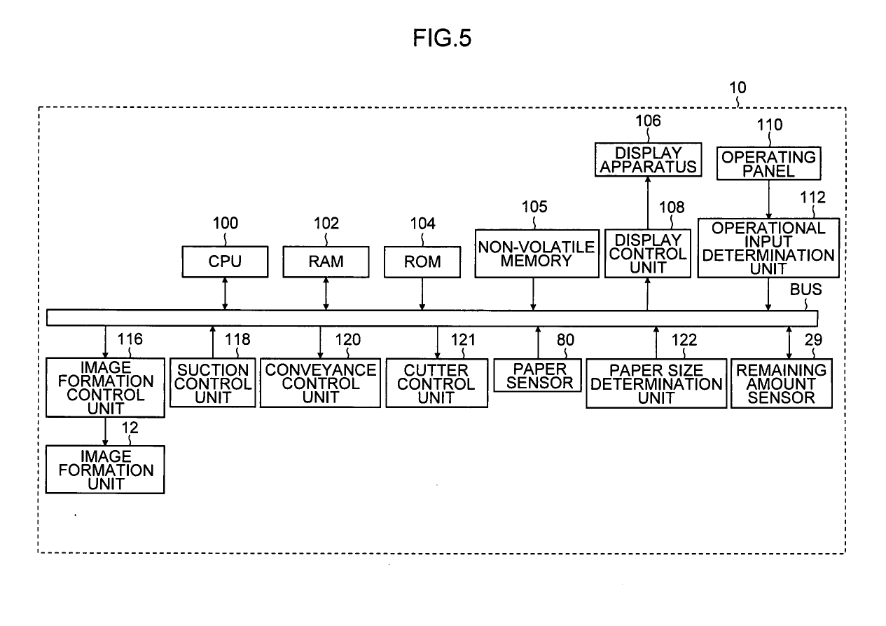

FIG. 5 is a principal part schematic drawing illustrating an overview of an electrical system of an image forming apparatus 10 according to the present embodiment.

As illustrated in FIG. 5, the image forming apparatus 10 comprises a CPU (central processing device) 100 which governs the operation of the whole apparatus, a RAM 102 which temporarily stores data of various kinds, a ROM 104 which previously stores various programs including a control program for controlling the whole apparatus and a suction control processing program as described hereinafter, and the like, a non-volatile memory 105 which stores information of various types, a display control unit 108 which is connected to a display apparatus 106, such as a liquid crystal display panel for displaying various operating screens, and which controls the display apparatus 106, and an operational input determination unit 112 which is connected to an operating panel 110 where a user inputs operational instructions of various kinds, and which determines operations performed on the operating panel 110.

Furthermore, the image forming apparatus 10 comprises an image formation control unit 116 which controls image formation processing by the image forming unit 12 described above, a suction control unit 118 which controls the suction fans 52A, 52B of the suction conveyance unit 42, a conveyance control unit 120 which controls the conveyance of the recording paper P, and a cutter control unit 121 which controls the cutting operations of the rear end cutter 17 and the cutter 20.

The conveyance control unit 120 controls the first roll conveyance unit 32 and the second roll conveyance unit 34, and thereby conveys recording paper P selectively to the main conveyance path 22. Furthermore, the conveyance control unit 120 controls the motors 82A and 82B so as to control the conveyance of the recording paper P along the main conveyance path 22.

The CPU 100, RAM 102, ROM 104, non-volatile memory 105, display control unit 108, operational input determination unit 112, image formation control unit 116, suction control unit 118, conveyance control unit 120 and cutter control unit 121 are mutually interconnected via the system bus BUS. Consequently, the CPU 100 is able to perform the following actions: accessing the RAM 102, ROM 104 and non-volatile memory 105, controlling the display of operating screens and the display of various types of information, such as messages, on the display apparatus 106 via the display control unit 108, controlling the operation of the image forming unit 12 via the image formation control unit 116, controlling the suctioning of the recording paper P via the suction control unit 118, and controlling the conveyance of the recording paper P via the conveyance control unit 120. Furthermore, the CPU 100 is also able to ascertain the operating contents of the operating panel 110 on the basis of the operating information determined by the operational input determination unit 112.

Furthermore, the paper sensor 80, the paper size determination unit 122 and the remaining amount sensor 29 are connected to the system bus BUS. The CPU 100 is able to ascertain whether or not recording paper P equivalent to one sheet at the maximum image size is held in the changing and bending section 22B, by means of a signal from the paper sensor 80. The paper size determination unit 122 determines the width of the roll-shaped recording paper 27 accommodated in the first roll type paper feed unit 26 and the second roll type paper feed unit 28 in accordance with the combination of on and off states of the mechanical switches which are provided respectively in the first roll type paper feed unit 26 and the second roll type paper feed unit 28. Consequently, the CPU 100 is able to ascertain the width of the roll-shaped recording paper 27 accommodated in the first roll type paper feed unit 26 and the second roll type paper feed unit 28, and to ascertain the remaining amount of the roll-shaped recording paper 27 accommodated in the first roll type paper feed unit 26 and the second roll type paper feed unit 28.

Below, the action of the present embodiment will be described. When forming an image, recording paper P which is the object of image formation is conveyed selectively from the long recording paper PR1 or PR2, to the main conveyance path 22.

When conveying the recording paper P, as illustrated in FIG. 3, one end of the recording paper P in the breadthways direction thereof is made to coincide substantially with one end of the air chamber forming member 50 in the breadthways direction thereof. If the suctioning pressure from the suction conveyance unit 42 is not acting, then the recording paper P curls slightly in a convex direction with respect to the main conveyance path 22.

When forming an image on the recording paper P, the CPU 100 executes a suction control processing program and controls the suction conveyance unit 42 to suction the recording paper P. Furthermore, the CPU 100 controls the image forming unit 12 so as to form images at each prescribed width on the recording paper P by scanning the carriage 16 and ejecting ink droplets from the inkjet recording head 14, and controls the motor 82A via the conveyance control unit 120 each time an image has been formed at a prescribed width, so as to drive the roller pairs 23A to rotate and convey the recording paper P intermittently in the conveyance direction.

Below, a case is described in which double-side image recording is carried out by using roll-shaped recording paper 27 (represented by the long recording papers PR1 or PR2, and recording paper P).

When forming images, the recording paper P is conveyed to the main conveyance path 22. In the suction conveyance unit 42, as illustrated in FIG. 3, the recording paper is conveyed in such a manner that one end of the recording paper P in the breadthways direction coincides with one end of the air chamber forming member 50 in the breadthways direction. If the suctioning force from the suction conveyance unit 42 is not acting, then the recording paper P curls slightly in a convex direction with respect to the main conveyance path 22.

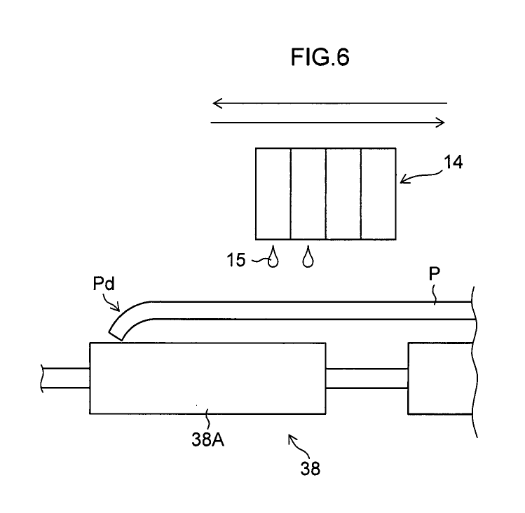

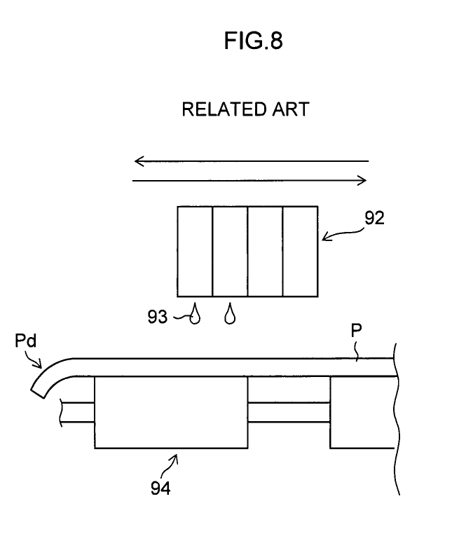

FIG. 6 is a diagram corresponding to FIG. 8 which illustrates a decurl device 92 in the related art, and illustrates the relationship between the width of the recording paper P and the width of the decurl device according to the present embodiment. Similarly to FIG. 8, FIG. 6 is a diagram for illustrating the relationship between the recording paper P and the inkjet head 14 during printing, and the relationship between the width of the recording paper P and the width of the decurl device, but the decurl device is not actually disposed directly below the inkjet recording head 14, and furthermore, the upper side decurl roller is not depicted (omitted).

In FIG. 6, the recording paper P is conveyed in a direction perpendicular to the paper depicted in the drawings (a direction which passes through the plane of the drawing), and the inkjet recording head 14 ejects ink droplets 15 toward the front surface of the recording paper P while scanning in a direction perpendicular to the conveyance direction of the recording paper P, as indicated by the left and rightward arrows in FIG. 6.

In this case, the recording paper P is conveyed in such a manner that the curl Pd of the edges is in the direction opposite to the surface on which the ink droplets 15 are deposited. Therefore, when the roll-shaped recording paper 27 is manufactured in the recording paper manufacturing installation, as illustrated in FIG. 1, by drawing the paper 2 out from a huge roll 1 and slitting it with the slitter 3 into recording papers of a prescribed width which are wound up respectively as small recording paper 4, the paper is manufactured in such a manner that curl occurring at the edges of the outer side surface H of the roll acts toward the opposite surface (towards the inner side of the roll). The roll-shaped recording paper 27 manufactured in this way is installed in the paper feed unit of the image forming apparatus 10 so as to be conveyed with the outer side surface H facing the inkjet recording head 14 of the image forming unit 12.

By this means, the first surface of the recording paper P conveyed from the roll-shaped recording paper 27 (the surface where image recording is carried out first in double-side printing) is conveyed so as to face the inkjet recording head 14, and moreover, as illustrated in FIG. 6, the paper is conveyed in such a manner that the edges are curled in the direction opposite to the surface on which the ink droplets 15 are deposited.

When forming an image on the recording paper P, the CPU 100 executes a suction control processing program and controls the suction conveyance unit 42 to suction the recording paper P. Furthermore, the CPU 100 controls the image forming unit 12 so as to form images at each prescribed width on the recording paper P by scanning the carriage 16 and ejecting ink droplets from the inkjet recording head 14, and controls the motor 82A via the conveyance control unit 120 each time an image has been formed at a prescribed width, so as to drive the roller pairs 23A to rotate and convey the recording paper P intermittently in the conveyance direction.

The CPU 100 ascertains the width of the recording paper P that is the object of image formation and judges whether or not the width of the recording paper P that is the object of image formation is equal to or less than a prescribed width. This prescribed width is a predetermined value set as the width at which it is possible to keep a uniform distance between the paper and the inkjet recording head 14 while ensuring the flatness of the recording paper P by suctioning from the air chamber 48A alone.

If the aforementioned judgment is positive, then negative pressure suctioning by the suction fan 52A is started and the recording paper P is suctioned only in the region corresponding to the air chamber 48A of the suction conveyance unit 42.

On the other hand, if the aforementioned judgment is negative, then negative pressure suctioning by both of the suction fans 52A and 52B is started, and the recording paper P is suctioned by the whole surface of the suction conveyance unit 42.

Thereupon, it is judged whether or not the remaining amount of recording paper P that is the object of image formation is equal to or less than a prescribed amount, and if the remaining amount of the recording paper P is equal to or less than the prescribed amount, then the rotational speed of the suction fans 52A and 52B during operation is accelerated, thereby increasing the suctioning force.

In this way, the recording paper P is suctioned and conveyed by the suction conveyance unit 42 and an image is formed on the front surface (first surface) of the recording paper P by ejection of ink from the inkjet recording head 14, in the image forming unit 12.

When an image has been formed on the front surface (first surface) side of the recording paper P, in order to form an image on the back surface (second surface) side by reversing the paper in terms of the front and back surfaces, the paper is cut at the rear end of the image that has just been formed, by the rear end cutter 17. After the recording paper P is cut by the rear end cutter 17, a warm air flow is directed onto the recording paper P from the drier 18, and the ink droplets which have been deposited onto the front surface of the recording paper P are caused to solidify.

Next, the conveyance direction of the recording paper P which has passed the rear end cutter 17 and the drier 18 is switched to an opposite direction and is conveyed on the reverse conveyance path 74.

The solvent included in the ink ejection droplets is absorbed in the coating layer or the paper fibers of the recording paper P, the front surface (first surface) of the recording paper P on which the image has been formed absorbs moisture and expands compared to the rear surface (second surface), whereby a force acts on the recording paper P having an image formed on the front surface thereof so that the recording paper P curls further in a convex shape on the front surface side. Furthermore, in this way, in the case of double-side printing, the state of the recording paper P varies depending on whether or not an image has been formed on the opposite surface, and therefore it is possible to alter the thickness of application on the respective surfaces by taking this into consideration.

In respect of the curl described above, the recording paper P is subjected to decurling by the decurling conveyance unit 38 in the reverse conveyance path 74. The direction of curl is reversed in the recording paper P which has been decurled by the decurling conveyance unit 38. In other words, when conveyed from the decurling conveyance unit 38, the recording paper P has a convex shape on the upper side (first surface side), whereas when the recording paper P is conveyed through the main conveyance path 22 in a second image formation step (image formation onto the rear surface (second surface) side), the recording paper P is conveyed in a shape which corresponds to the shape of the conveyance path, similarly to the first image formation step, and the front end of the paper does not float up from the main conveyance path 22.

Furthermore, in the present embodiment, as illustrated in FIG. 6, the decurl roller 38A in the decurling conveyance unit 38 is composed so as to cover a range broader than the width of the recording paper P, and in particular, it is possible to flatten the burring of the edges of the recording paper P and to reverse the curl Pd in the opposite direction.

Moreover, this decurling roller 38A has a uniform hardness sufficient to flatten the burring, especially in the portions which make contact with the edges of the recording paper P. If the decurling roller 38A is a long roller which makes contact with the whole width of the recording paper P, then unless the roller is manufactured with sufficiently high precision, it is not possible to nip the recording paper P correctly, and manufacturing a high-precision roller of this kind involves increased costs. Therefore, as illustrated in FIG. 6, the decurl roller 38A is constituted by aligning a plurality of rollers each having a short length.

Here, it is possible to alter the interval between edge pressurizing rollers for flattening burr in the edges which are provided at either end of the recording paper P, separately from the decurl roller which deals with the main body (stiffness) of the recording paper P, in accordance with the width of the recording paper P, in such a manner that the edges can be pressed by the rollers at all times even if the width of the recording paper P varies.

In this way, when the recording paper P which has been decurled by the decurling conveyance unit 38 is conveyed to the image forming unit 12 again via the main conveyance path 22, the rear surface (second surface) faces the inkjet recording head 14 of the image forming unit 12, but in this case, the edges curl in the direction opposite to the second surface on which the ink droplets are to be ejected.

Since the edges of the recording paper P curl in the opposite direction in this way, then the flatness of the recording paper P is increased and the distance between the recording paper P and the inkjet recording head 14 is stabilized.

Consequently, when an image is formed on the rear surface (second surface) of the recording paper P, the recording paper P and the inkjet recording head 14 have a similar positional relationship to that illustrated in FIG. 6, and since there is no burring of the edges of the recording paper P, then when an image is recorded by depositing ink droplets, a clearer image can be expected and high-definition image recording can be achieved.

In this way, according to the present embodiment, in an image forming apparatus for double-side printing, recording paper having the shape of a roll which has been manufactured in such a manner that both edges of the outer side surface (front surface, first surface) of the roll curl toward in the direction opposite to the front surface is installed in a paper feed unit of the image forming apparatus. When the paper is reversed in order to form an image on the rear surface (second surface) after forming an image on the front surface (first surface) and the paper is then conveyed again to the image forming unit, in the decurling conveyance unit for carrying out decurling to return the main body (stiffness) of the paper to a state which is originally provided in an image forming apparatus for double-side printing, burring of the edges of the recording paper is simultaneously flattened and the direction of curl of the paper is reversed, in such a manner that the paper curls in the direction opposite to the image forming surface when an image is formed on the rear surface (second surface). In this way, images of high definition can be formed on both surfaces.

In other words, firstly, when manufacturing roll-shaped recording paper by cutting a large roll with a slitter, the paper is wound up in a roll shape in such a manner that the curling surface of the cut edge produced by the slitter is on the front surface, and this recording paper is installed in the paper feed unit of the image forming apparatus. Thereupon, before recording on the rear surface, the paper is smoothed by flattening the burr of the edges of the recording paper which has been reversed by the decurl roller of the decurling conveyance unit. By combining roll-shaped recording paper and an image forming apparatus which have been manufactured in this way, it is possible to create double-side prints of high definition in a stable fashion.

Since the decurling conveyance unit which is provided in an image forming apparatus for double-side printing is also made to serve as an edge pressurizing (stamping) roller for the recording paper P, then it is possible to reduce the manufacturing costs of the apparatus.

An image forming system according to the present invention has been described in detail above, but the present invention is not limited to the aforementioned examples, and it is of course possible for improvements or modifications of various kinds to be implemented, within a range which does not deviate from the essence of the present invention.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming system comprising:
a recording medium which has a roll shape and is manufactured so as to have both edges curling in a direction opposite to a roll surface of the recording medium;
an image forming device which forms an image on the recording medium conveyed along a conveyance path;
a recording medium feeder in which the recording medium having the roll shape is loaded in such a manner that the recording medium having the roll shape is conveyed while the roll surface of the recording medium faces the image forming device;
a rear end cutter for cutting the recording medium having the roll shape on which the image forming device has formed an image on the roll surface, at a position posterior to the formed image;
a reverse conveyance path in which the recording medium, on the roll surface of which the image has been formed and which has been cut by the rear end cutter, is reversed in terms of front and back surfaces of the recording medium; and
a decurl device for reversing a curl direction of the recording medium which has been reversed in terms of the front and back surfaces and is conveyed in the reverse conveyance path,
wherein images are formed on the front and back surfaces of the recording medium by forming an image on the front surface of the recording medium having the roll shape, cutting the recording medium at the position posterior to the image, reversing the recording medium in terms of the front and back surfaces, reversing curl of the edges of the recording medium in an opposite direction by the decurl device, and then forming an image on the back surface of the recording medium.

2. The image forming system as defined in claim 1, wherein the recording medium having the roll shape is manufactured by cutting a paper supplied from a large roll with a slitter in a direction in which the paper is conveyed, and taking up the cut paper in form of a roll in such a manner that a surface of the cut paper which is reverse to a side on which the edges of the cut paper curl forms the roll surface.

3. The image forming system as defined in claim 1, wherein the decurl device includes a decurl roller for pressurizing at least the edges of the recording medium.

4. The image forming system as defined in claim 3, wherein the decurl roller has a uniform hardness enabling the curl of the edges of the recording medium to be reversed in the opposite direction.

5. The image forming system as defined in claim 1, wherein the image forming device forms an image on a surface of the recording medium which is reverse to a side on which the edges of the recording medium curl.
